(19) United States
(12) Patent Application Publication
(10) Pub. No.: US 2014/0034155 A1
(43) Pub. Date: Feb. 6, 2014

(54) Valve Seat For A Pressure Regulator

(71) Applicant: Fairchild Industrial Products Company, Winston-Salem, NC (US)

(72) Inventor: Andy R. Askew, Pfafftown, NC (US)

(73) Assignee: Fairchild Industrial Products Company, Winston-Salem, NC (US)

(21) Appl. No.: 13/955,118

(22) Filed: Jul. 31, 2013

Related U.S. Application Data
(60) Provisional application No. 61/677,838, filed on Jul. 31, 2012.

(51) Int. Cl. F16K 25/00

(52) U.S. Cl. CPC F16K 25/00
USPC 137/505; 251/359

(57) ABSTRACT

Improved valve seats for pressure regulators, as well as improved pressure regulators, are disclosed. For example, in one disclosed embodiment, a valve seat may comprise a first valve seat surface; a second valve seat surface opposite the first valve seat surface; a compression seal area; and a concentric stress relief groove on the first valve seat surface.

### CROSS REFERENCE TO RELATED APPLICATIONS

This application claims priority to Provisional Application No. 61/677,838 filed Jul. 31, 2012, and entitled “Improved Valve Seat for Pressure Regulator,” the entirety of which is hereby incorporated by reference herein.

### BACKGROUND

Pressure regulators are often used to vary the pressure of one or more gases. In some embodiments, these gases may comprise a gas that is volatile, corrosive, and/or expensive. Thus, it is preferable to avoid loss of the gas. In some embodiments, pressure regulators may make use of valve seats made of a soft material that forms a seal when compressed. However, in some embodiments, applying pressure to this soft material may cause it to deform and weaken the seal.

Further, in some applications, pressure regulators may be adapted for use with gases having a high inlet pressure; thus, in some embodiments, large flows can be obtained with very small valves. The small valves and valve seats can be difficult to manufacture as highly accurate machining of the components may be required to form an effective seal when the valve and valve seat are mated. One solution may comprise using a conventional polymeric material for the valve seat. However, in some embodiments the valve seat is retained and sealed by employing a compressive seat at the outer edge. Stress induced in the polymeric material can travel some distance from the compressed area and distort the seat sealing surface. Further, in some embodiments, non-amorphous polymers may include crystalline structures that distort in different levels along crystalline planes in response to the compressive stress. The uneven distortion of the seat can lead to undesirable leakage between the valve and the valve seat once installed. In some embodiments, this may lead to a weak seal that allows some of the gases to escape past the valve causing some loss of pressure regulation.

### SUMMARY

Various embodiments of the present invention relate to improved valve seats for pressure regulators and to pressure regulators. For example, in one disclosed embodiment, a valve seat comprises a first valve seat surface, a second valve seat surface opposite the first valve seat surface, a compression seal area, and a concentric stress relief groove on the first valve seat surface.

In another disclosed embodiment, a system for an improved valve seat for a pressure regulator comprises a pintle comprising a supply valve; a supply valve seat configured to receive the supply valve and a piston coupled to the pintle and configured to actuate the pintle to open the supply valve; wherein the supply valve seat comprises a concentric stress relief groove on a supply valve seat surface.

These illustrative embodiments are mentioned not to limit or define the limits of the present subject matter, but to provide an example to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

FIG. 1 is a diagram representing a view of a pressure regulator according to one embodiment of the present disclosure;

FIG. 2 is a diagram representing a view of a valve seat according to one embodiment of the present disclosure;

FIG. 3 is a diagram representing a view of a valve seat according another embodiment of the present disclosure;

FIG. 4 is a diagram representing a view of a valve seat according another embodiment of the present disclosure;

FIG. 5 is a diagram representing a view of a valve seat according another embodiment of the present disclosure; and

FIG. 6 is a diagram representing a view of a pressure regulator according to one embodiment of the present disclosure.

### DETAILED DESCRIPTION

For the purposes of this specification, unless otherwise indicated, all numbers used in the specification are to be understood as being modified in all instances by the term “about.” Accordingly, unless indicated to the contrary, the numerical parameters set forth in the following specification are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of this disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

### Illustrative Embodiment of an Improved Valve Seat for a Pressure Regulator

The present disclosure generally relates to general purpose pressure reducing pressure regulators. According to one embodiment of the present disclosure a pressure regulator may employ an unbalanced supply valve that comprises a steel or stainless steel valve and some type of polymer valve seat. The polymer valve seat may provide compliance to aid in reliable sealing and may also provide a dissimilar bearing type material for enhanced wear characteristics.

In some embodiments, pressure regulators are selected for applications involving expensive bottled gases or other process conditions of fluids or gases where undesirable leakage of the gas or fluid media will have adverse effects on cost and/or the resultant downstream process or product. In some embodiments, the gas may comprise, for example and without limitation, air, helium, hydrogen, oxygen, hydrocarbon-based gases (e.g., natural gas, methane, propane, etc.), or other gases typically used in industrial, commercial, or consumer applications. In some applications, the gas may be flammable, corrosive and/or toxic requiring stainless steel construction for the majority of the components as well as a highly engineered and expensive polymer valve seat material. Due to such costs, it may be desirable in some embodiments to minimize the volume of the expensive valve seat material.

One solution may comprise using a conventional polymeric valve seat and a compression seal. However, in some embodiments, stress induced in the polymeric material can travel some distance from the compressed area and distort the seat sealing surface. Further, in some embodiments, non-amorphous polymers may include crystalline structures that distort in different levels along crystalline planes in response to the compressive stress. The uneven distortion of the seat can lead to undesirable leakage between the valve and the valve seat once installed. In some embodiments, this may lead to a weak seal that allows some of the gases to leak past the valve.

Some embodiments of the present disclosure may provide solutions to the issue of valve seat distortion. One embodiment of the present disclosure comprises a concentric groove on at least one surface of the polymer valve seat. A concentric groove with a generous radius along the face of the valve seat may interrupt the transmission of stress to the seating surface. For example, in some embodiments, the pressure may cause deformities, such as folds or bends. These folds or bends may travel across the valve seat, and weaken the sealing properties of the valve seat.

In some embodiments, a stress relieving groove in a polymeric valve seat may improve contact between the seat and the corresponding valve. Thus, in some embodiments, when the valve is pressurized against the seat, leakage of the gas will not occur. Further, some embodiments may comprise additional stress relief grooves. For example, in some embodiments, a stress relief groove can be on either face or even on both faces of a valve seat. Alternatively, in some embodiments, one or both faces of the valve seat may comprise a plurality of stress relief grooves.

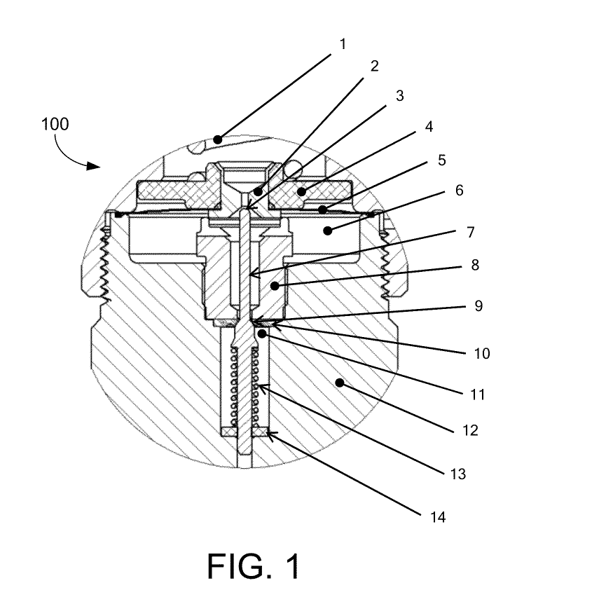

Turning now to FIG. 1, FIG. 1 shows a view of an improved valve seat for a pressure regulator according to one embodiment of the present disclosure. According to the embodiment shown in FIG. 1, a pressurized gas or liquid media source is ported to an inlet chamber 11. In some embodiments, the gas may comprise, for example and without limitation, air, helium, hydrogen, oxygen, hydrocarbon-based gases (e.g., natural gas, methane, propane, etc.), or other gas typically used in industrial, commercial, or consumer applications.

As shown in FIG. 1, a supply pintle 7 is disposed upward by a valve spring 13 such that a spherical supply valve 9 contacts supply valve seat 10 forming a pressure seal and prevents the pressurized gas in the inlet chamber 11 from flowing into the outlet chamber 6. In the embodiment shown in FIG. 1, spring 13 and pintle 7 are held in place by valve guide 14. Further, in the embodiment shown in FIG. 1, a pressurized gas present in the outlet chamber 6 may be relieved by flowing out of an exhaust valve 3.

As shown in FIG. 1, the compression of the range spring 1 exerts a downward force upon piston 4. The piston is coupled to a relief seat 2, and moves downward to make contact with the exhaust valve 3 of the pintle 7, thus sealing the exhaust valve, and preventing any further escape of the gas from outlet chamber 6.

As shown in FIG. 1, continued downward movement of the piston 4 begins to move the pintle 7 in concert with the piston 4 and moves the supply valve 9 off of the mating supply valve seat 10 allowing the pressurized gas in the inlet chamber 11 to flow across the open supply valve 9 and into the outlet chamber 6.

As shown in FIG. 1, supply valve seat 10 is held in place via a pressure seal between valve seat retainer 8 and valve body 12. In some embodiments, this pressure seal comprises downward force applied by valve seat retainer 8 onto supply valve seat 10, which presses supply valve seat 10 into valve body 12. Further, in some embodiments, supply valve seat 10 comprises a compression seal area, which is configured to receive the pressure applied by valve seat retainer 8.

In some embodiments, supply valve seat 10 comprises one or more stress relief grooves on one or both of its faces. These stress relief grooves may comprise concentric grooves configured to interrupt some of the stress applied by the compression seal. For example, these grooves may distort or bend in response to the compressive stress, thus enabling the remainder of the valve seat to maintain its ordinary shape. In some embodiments, this leads to a more reliable and longer lasting seal.

In the embodiment shown in FIG. 1, as the pressure rises in the outlet chamber 6 in response to the pressurized gas flowing from the inlet chamber 11 and through supply valve 9, the pressure exerts an upward force on diaphragm 5 that opposes the force of the range spring 1.

As the pressure continues to rise, the increasing force developed by the pressure in the outlet chamber 6 acting on the area of diaphragm 5 will move the piston 4 upward. The movement of the piston 4 causes the pintle 7 to move upward and close the supply valve 9 with the supply valve seat 10. In some embodiments, this may occur at a specific outlet pressure determined by force balance principals involving the force developed by range spring 1, the effective area of diaphragm 5 and the outlet chamber 6 pressure. In some embodiments, this may form a mechanical pressure regulating feedback system.

As described above, in some embodiments, the valve seats may comprise compression seal valve seats. In some embodiments, stress induced in the polymer can travel some distance from the compressed area and distort the seat sealing surface. In some embodiments, this may lead to a weak seal that allows some of the gases from the inlet chamber to escape to the outlet chamber even though the supply valve is closed. To solve this problem, one embodiment of the present disclosure comprises a concentric groove along the polymer valve seat.

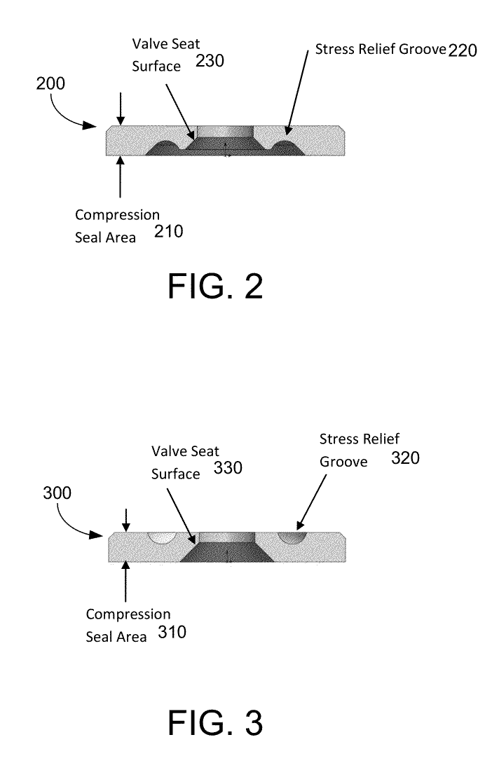

Turning now to FIG. 2, FIG. 2 shows a cutaway view of a valve seat 200 comprising a stress relief groove according to one embodiment of the present disclosure. In some embodiments, the valve seat 200 is a round valve seat, comprising a hole near its center, configured to receive a valve. In other embodiments, other shapes such as squares, rectangles, or ellipses are possible, each with any number of potential shapes for a through hole. As shown in FIG. 2, the valve seat 200 may be constructed from a polymeric material. In some embodiments, the valve seat may be constructed from, for example, ABS, epoxy, nylon, polyester, PVS, SBS, rubber, silicone, PTFE, polystyrene, polyethylene, as well as other polymeric materials.

As shown in FIG. 2, the valve seat 200 comprises a compression seal area 210. In some embodiments, such as in a pressure regulator, pressure applied to the compression seal area forms a seal when a valve seat retainer (not shown in FIG. 2) applies pressure to one face of the valve seat. The pressure applied by the valve seat retainer presses the valve seat into the valve body, thus forming a seal. In some embodiments, the pressure is applied to the compression seal area 210, which is shown in FIG. 2 by two opposing arrows.

Further, as shown in FIG. 2, the polymer valve seat comprises a stress relief groove 220 on its underside. In some embodiments, this groove may interrupt the transmission of stress to the seating surface. In some embodiments, stress may appear on the valve seat as bends, folds, stretches, or other deformities. Stress relief groove 220 may interrupt, or absorb, this stress by bending, stretching, flattening out, or otherwise changing shape. In some embodiments, this may serve to prevent the stress from impacting the valve seat surface 230. For example, in some embodiments, despite any deformation caused by pressure on compression seal area 210, valve seat surface 230 may maintain its form. This may cause the valve seat to maintain its shape, and thus form a better and longer lasting seal. This may ultimately reduce leakage of the gas.

Turning now to FIG. 3, FIG. 3 shows a cutaway view of a valve seat 300 comprising a stress relief groove 320 according to one embodiment of the present disclosure. As shown in FIG. 3, the valve seat 300 may be constructed from a polymeric material. Further, as shown in FIG. 3, the valve seat 300 comprises a compression seal area 310. In some embodiments, such as in a pressure regulator, pressure applied to or in the compression seal area forms a seal when a valve seat retainer (not shown in FIG. 3) applies pressure to one face of the valve seat. The pressure applied by the valve seat retainer presses the valve seat into the valve body, thus forming a seal. In some embodiments, the pressure is applied to the compression seal area 310, which is shown in FIG. 3 by two opposing arrows.

Further, as shown in FIG. 3, the polymer valve seat comprises a stress relief groove 320 on its topside. This groove may interrupt the transmission of stress to the seating surface. In some embodiments, stress may appear on the valve seat as bends, folds, stretches, or other deformities. Stress relief groove 320 may interrupt, or absorb, this stress by bending, stretching, flattening out, or otherwise changing shape. In some embodiments, this may serve to prevent the stress from impacting the valve seat surface 330. For example, in some embodiments, despite any deformation caused by pressure on compression seal area 310, valve seat surface 330 may maintain its form. This may cause the valve seat to maintain its shape, and thus form a better and longer lasting seal. This may ultimately reduce leakage of the gas.

As shown in FIG. 3, stress relief groove 320 comprises a different shape than that of stress relief groove 220 (described above with regard to FIG. 2). In some embodiments, the stress relief groove may comprise one of a plurality of available shapes. In some embodiments, these shapes may be configured to interrupt specific types of stress, for example, in one embodiment a specific shape of groove may be configured to interrupt stress in the form of wrinkling. In another embodiment, a different shape of groove may be configured to interrupt stress associated with stretching.

In some embodiments, not shown in FIG. 2 or 3, a valve seat may comprise additional stress relief grooves. For example, in some embodiments, multiple stress relief grooves can be on either face or even on both faces of the valve seat.

Further, in some embodiments of the present disclosure, the valve pintle may comprise a spherical shape. This spherical shape may improve the alignment of the valve pintle with the valve seat. In some embodiments, this may enable the valve pintle to not be perfectly aligned with the valve seat, but still form a strong seal. Further, in some embodiments, a spherical valve pintle may be less likely to move outside of its seating area, and thus may form a better seal.

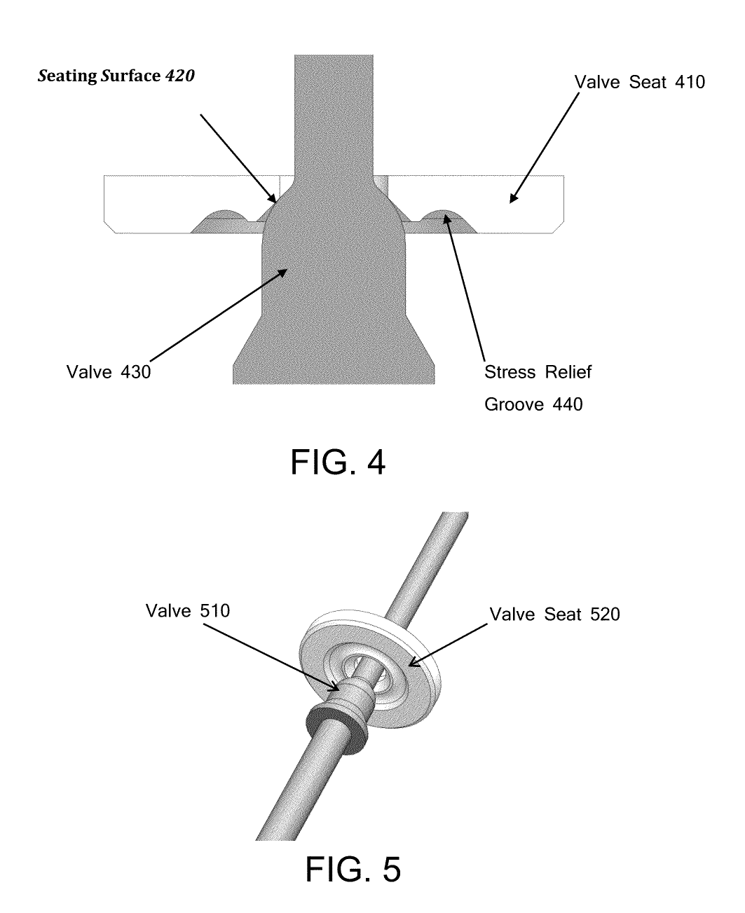

Turning now to FIG. 4, FIG. 4 shows a diagram of a valve seat 410 configured to receive a valve 430. As shown in FIG. 4, seating surface 420 is configured to receive valve 430 and form a seal that prevent gas or other media from passing.

As discussed above, in some embodiments, valve seat 410 may be held in place via a compression seal provided by a valve seat retainer (not shown) applying pressure to the outer edge of the valve seat 410. In some embodiments, this pressure causes stress through the material of valve seat 410. In some embodiments, this stress may deform the valve seat by stretching, flexing, or compressing the valve seat 410. For example, in some embodiments, the seating surface 420 may distort into a different shape, e.g., a round seating surface 420 may be distorted to have a slightly rectangular, square, or diamond shape. In some embodiments, this may weaken the seal between seating surface 420 and valve 430.

To solve this problem, the embodiment shown in FIG. 4 further comprises a stress relief groove 440. Stress relief groove 440 may interrupt, or absorb, this stress by bending, stretching, flattening out, or otherwise changing shape. In some embodiments, this may serve to prevent the stress from impacting the valve seat surface 420. For example, in some embodiments, despite any deformation caused by pressure on the valve seat 410, seating surface 420 may maintain its form. This may cause the valve seat to maintain its shape, and thus form a better and longer lasting seal. This may ultimately reduce leakage of the gas.

Further, as shown in FIG. 4, valve 430 may comprise a spherical shape. This spherical shape may improve the alignment of the valve 430 with the valve seat 410. In some embodiments, this may enable the valve 430 to not be perfectly aligned with the valve seat 410, but still form a strong seal. Further, in some embodiments, a spherical valve 430 may be less likely to move outside of seating surface 420, and thus may form a better seal.

Turning now to FIG. 5, FIG. 5 shows a view of a valve 510 coupled to a valve seat 520. As described above, in some embodiments, both valve 510 and valve seat 520 may be coupled to a plurality of other components, e.g., a valve seat retainer, spring, and other components of a pressure regulator. As shown in FIG. 5, valve seat 520 comprises a circular shape. Further, valve 510 comprises a spherical shape in order to help it form a better seal with valve seat 520.

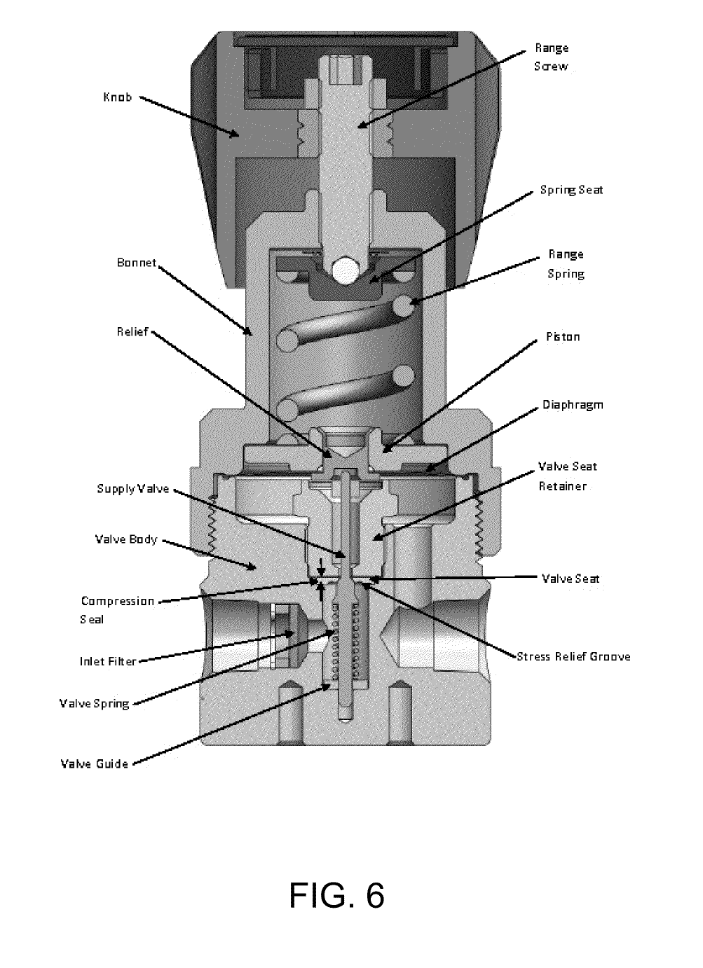

Turning now to FIG. 6, FIG. 6 comprises a diagram of another embodiment of a pressure regulator according to the present disclosure. As shown in FIG. 6, the pressure regulator comprises many of the components described above with regard to FIG. 1. Further, as shown in FIG. 6, the pressure regulator comprises a valve seat, with a stress relief groove highlighted.

Further, as shown in FIG. 6, the pressure regulator comprises a knob and range screw configured to adjust the tension on the range spring. In some embodiments, adjusting the tension on the range spring may adjust the variable pressure output of the pressure regulator.

### Advantages of an Improved Valve Seat for a Pressure Regulator

Some embodiments of the present disclosure may improve the ability of the pressure regulator to operate with minimal, or in some cases, no undesirable leakage of the gas across the valve seat. Further, some embodiments of the present disclosure may reduce the need for accurate machining of the valve seat. This may reduce the total cost of producing a new pressure regulator, without reducing the quality or lifespan of the end product.

### General Considerations

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed is:

1. A valve seat comprising:
a first valve seat surface;
a second valve seat surface opposite the first valve seat surface;
a compression seal area; and
a concentric stress relief groove on the first valve seat surface.

2. The valve seat of claim 1, further comprising a second concentric stress relief groove on the second valve seat surface.

3. The valve seat of claim 1, wherein the valve seat is constructed from a polymeric material.

4. The valve seat of claim 1, wherein the concentric stress relief groove is configured to interrupt the transmission of stress to the first valve seat surface and the second valve seat surface.

5. The valve seat of claim 1, wherein the concentric groove is configured to prevent distortion of the valve seat.

6. A pressure regulator comprising:
a pintle comprising a supply valve;
a supply valve seat configured to receive the supply valve and
a piston coupled to the pintle and configured to actuate the pintle to open the supply valve;
wherein the supply valve seat comprises a concentric stress relief groove on a supply valve seat surface.

7. The pressure regulator of claim 6, wherein the pintle comprises a spherical supply valve.

8. The pressure regulator of claim 6, wherein the supply valve seat further comprises a second concentric stress relief groove on a second valve seat surface.

9. The pressure regulator of claim 6, wherein the supply valve seat is constructed from a polymeric material.

10. The pressure regulator of claim 6, wherein the concentric stress relief groove is configured to interrupt the transmission of stress to the valve seat surface.

11. The pressure regulator of claim 6, wherein the concentric groove is configured to prevent distortion of the valve seat.
